(19) United States
(12) Patent Application Publication
(10) Pub. No.: US 2016/0232824 A1
(43) Pub. Date: Aug. 11, 2016

(54) POSTER DISPLAY DEVICE

(71) Applicant: Nottingham Spirk Design Associates, Cleveland, OH (US)

(72) Inventors: Rachel NOTTINGHAM COLOSIMO, Cleveland Heights, OH (US); Nicholas E. STANCA, Westlake, OH (US); Rebecca L. BLICE, Akron, OH (US); James E. SZPAK, Cleveland Heights, OH (US)

(21) Appl. No.: 14/615,779

(22) Filed: Feb. 6, 2015

(51) Int. Cl. G09F 15/02; G09F 13/18; G09F 13/22

(52) U.S. Cl. CPC G09F 15/025; G09F 13/22; G09F 13/18; G09F 2013/222

(57) ABSTRACT

A poster display device includes a top poster bar configured to connect to a top edge of the poster, a bottom poster bar configured to connect to a bottom edge of the poster, and a housing including at least one device hanging fastener and configured to mount the device to a wall. The housing also includes at least one poster hanging fastener corresponding to at least one housing engaging fastener of the top poster bar such that the poster held by the top poster bar attaches to the housing by the poster hanging fasteners of the housing engaging the housing engaging fasteners of the top poster bar. The housing includes light sources distributed along a length of the housing oriented such that light emitted from the light sources is directed at the poster when the poster held by the top poster bar is attached to the housing.

### FIELD OF THE INVENTION

The present disclosure relates generally to the field of display devices. In particular, the present disclosure relates to a device that is used to hold and display a poster.

### BACKGROUND

Posters for movies or TV shows have become a popular form of art. In particular, posters that depict images or characters from movies or TV shows have become popular items to decorate walls in homes and businesses. The posters come in a variety of sizes and may include black and white images or full color images. Posters are often plainly hung on a wall or sometimes framed for hanging on the wall.

An issue with current methods of displaying posters is that the posters cannot be adequately seen in a dark room. Another deficiency of current methods of displaying posters is that hanging posters directly to a wall may not be very attractive. Also, removing posters from the wall may be messy or may cause damage to the wall. Even framed posters may be difficult and time-consuming to remove from the frame so that they may be removed or replaced.

### SUMMARY OF THE INVENTION

The invention relates to a device that is used to hold and display a poster. The device holds the poster extended upon a wall and includes light sources that shine light upon the poster. Installing and removing posters using the disclosed device is a relatively quick and easy procedure that minimizes damage to the wall. Importantly, using the disclosed device, a poster may be elegantly displayed and may be properly seen even in a dark room.

These and further features of the present invention will be described with reference to the attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the terms of the appended claims.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an exemplary poster display device including a housing, a top poster bar and a bottom poster bar.

FIG. 2 illustrates additional details of the exemplary top poster bar and the exemplary bottom poster bar of the exemplary poster display device.

FIGS. 3A and 3B illustrate details of the exemplary bottom poster bar.

FIG. 4 illustrates a top perspective view of the exemplary poster display device with the top poster bar unattached to the housing.

FIG. 5 illustrates a top perspective view of the exemplary poster display device with the top poster bar attached to the housing.

FIG. 6 illustrates a bottom perspective view of the exemplary poster display device with the top poster bar attached to the housing.

FIG. 7 illustrates a side view of the exemplary poster display device with the top poster bar attached to the housing.

### DETAILED DESCRIPTION

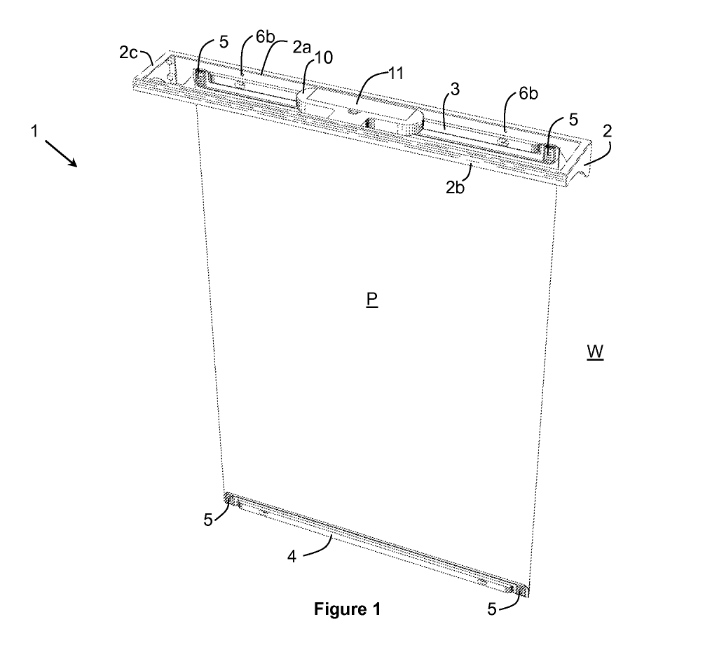

FIG. 1 illustrates an exemplary poster display device 1 that may be used to hold and display a poster P. The display device 1 holds the poster P extended and shines light upon the poster P. The device 1 includes three main components: a housing 2, a top poster bar 3 and a bottom poster bar 4. The top poster bar 3 and the bottom poster bar 4 may be attached to the poster P. As described in detail below, the housing 2 and the top poster bar 3 include corresponding fasteners such that the top poster bar 3 may be connected to the housing 2 thereby connecting the poster P to the housing 2. The bottom poster bar 4 may act as weight to extend the poster P and to counteract any memory resulting from folding or rolling of the poster P prior to display. The housing 2 also includes light sources (not shown in FIG. 1) that shine light upon the poster P connected to the housing 2. This results in an easily deployable, relatively inexpensive, yet elegant arrangement for displaying the poster P.

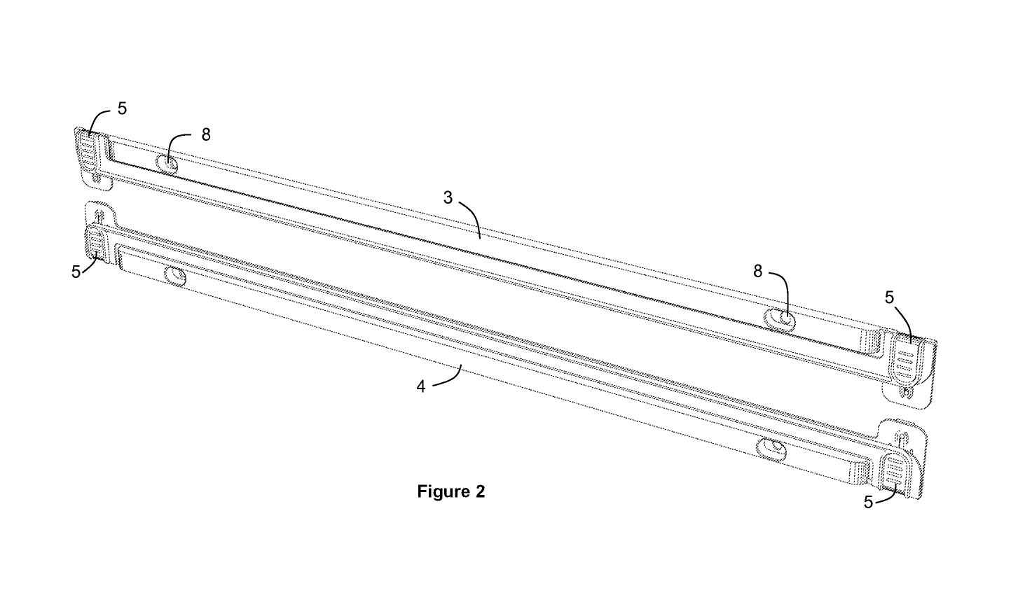

FIG. 2 illustrates additional details of the top poster bar 3 and the bottom poster bar 4 of the exemplary poster display device 1. The top poster bar 3 includes clips 5 to connect the top poster bar 3 to the top edge of the poster P. The bottom poster bar 4 may include similar clips 5 to connect the bottom poster bar 4 to the bottom edge of the poster P. In one embodiment, the top poster bar 3 and the bottom poster bar 4 are the same design and are interchangeable with one another. In other embodiments, the top poster bar 3 and the bottom poster bar 4 are different in at least some respects.

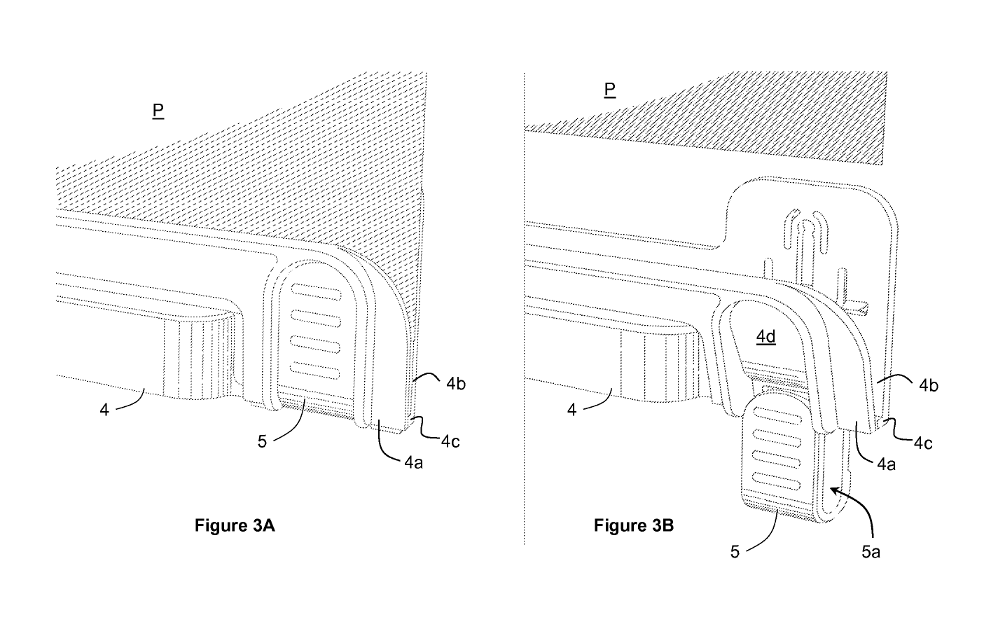

As best seen in FIGS. 3A and 3B, the bottom poster bar 4 includes a first poster engaging portion 4a, a second poster engaging portion 4b opposite the first poster engaging portion 4a and a hinge portion 4c hingedly connecting the first poster engaging portion 4a and the second poster engaging portion 4b. The clip 5 is u-shaped to sandwich the first poster engaging portion 4a and the second poster engaging portion 4b between the opening 5a of the clip 5.

In the illustrated embodiment of FIG. 3B, the bottom poster bar 4 also includes a ramping portion 4d disposed such that, as the clip 5 slides along the first poster engaging portion 4a and the second poster engaging portion 4b, the clip 5 urges the first poster engaging portion 4a and the second poster engaging portion 4b towards each other. Sliding the clip 5 to full engagement of the first poster engaging portion 4a and the second poster engaging portion 4b effectively locks or traps the edge of the poster P between the first poster engaging portion 4a and the second poster engaging portion 4b. To release the poster P the same steps may be taken but in reverse; i.e., pulling the clip 5 away from the bottom poster bar 4 to allow the first poster engaging portion 4a and the second poster engaging portion 4b to separate.

The top poster bar 3 and the clips 5 associated with the top poster bar 3 operate in a similar manner to engage or disengage the top edge of the poster P.

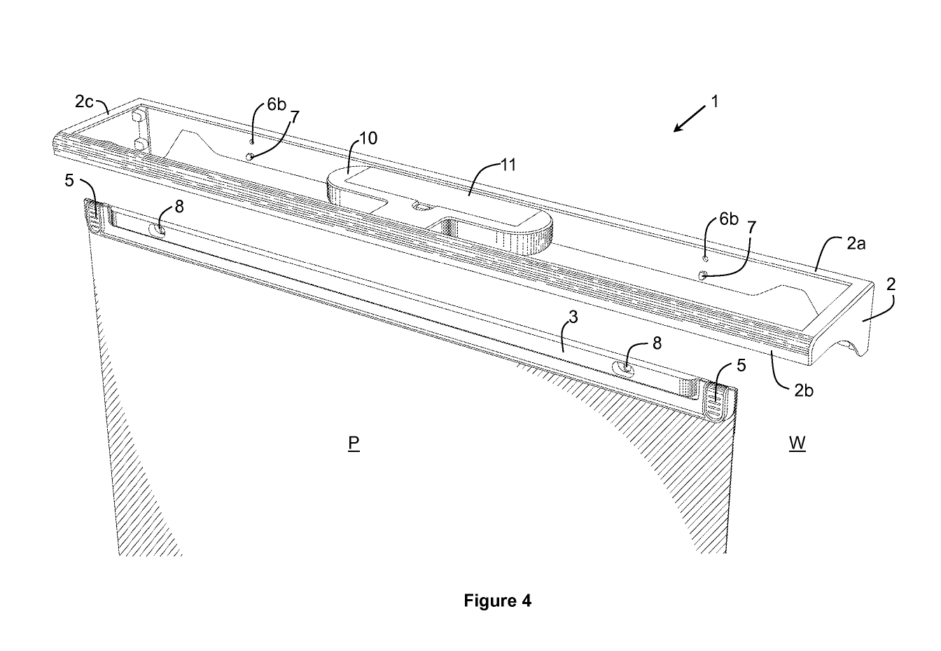

FIG. 4 illustrates a top perspective view of the exemplary poster display device 1 with the top poster bar 3 unattached to the housing 2. The housing 2 includes a proximal portion 2a, a distal portion 2b and middle portions 2c that connect the proximal portion 2a and the distal portion 2b.

The housing 2 also includes poster hanging fasteners 7, which, in the illustrated embodiment are located in the proximal portion 2a. In other embodiments, the poster hanging fasteners 7 may be located in portions of the housing 2 or the device 1 different from the proximal portion 2a. The top poster bar 3 also includes housing engaging fasteners 8 disposed along the length of the top poster bar 3. In the illustrated embodiment, the fasteners 8 of the top poster bar 3 are holes and the fasteners 7 of the housing 2 are hooks corresponding in design and location to each other.

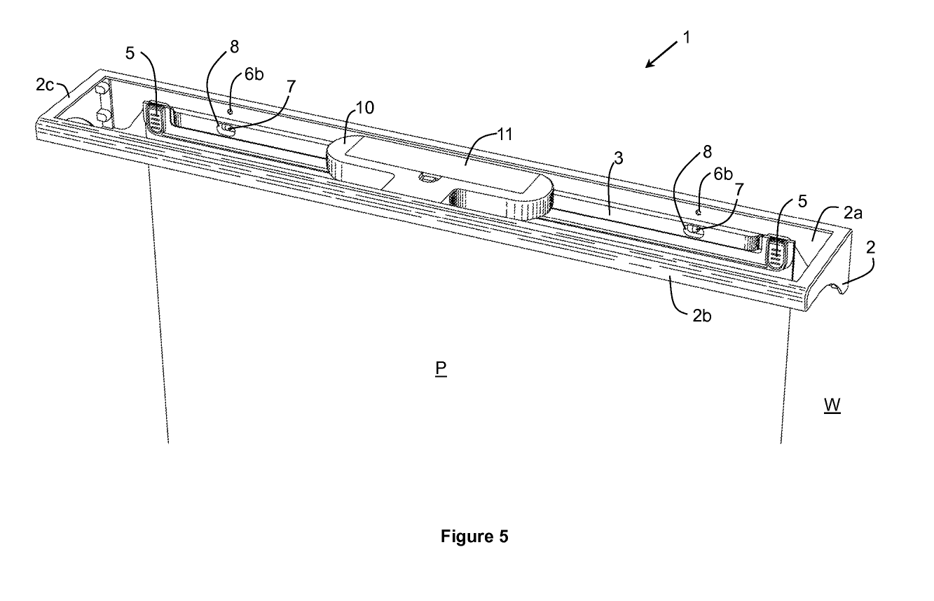

FIG. 5 illustrates a top perspective view of the exemplary poster display device 1 with the top poster bar 3 attached to the housing 2. As shown on FIG. 5, the fasteners 7 of the housing 2 engage the fasteners 8 of the top poster bar 3. This way the poster P is held by the clips 5 of the top poster bar 3 and the top poster bar 3 attaches to the housing 2 by the hooks 7 engaging the holes 8. In one embodiment, the fasteners 8 of the top poster bar 3 may be hooks while the fasteners 7 of the housing 2 may be holes. In other embodiments, the fasteners 8 of the top poster bar 3 and the fasteners 7 of the housing 2 may be corresponding fasteners other than holes or hooks (e.g., clips, screws, Velcro®, adhesives, etc.) Moreover, although the illustrated embodiment includes two pairs of fasteners, in other embodiments the device 1 may include fewer or more than two pairs of fasteners to attach the top poster bar 3 to the housing 2.

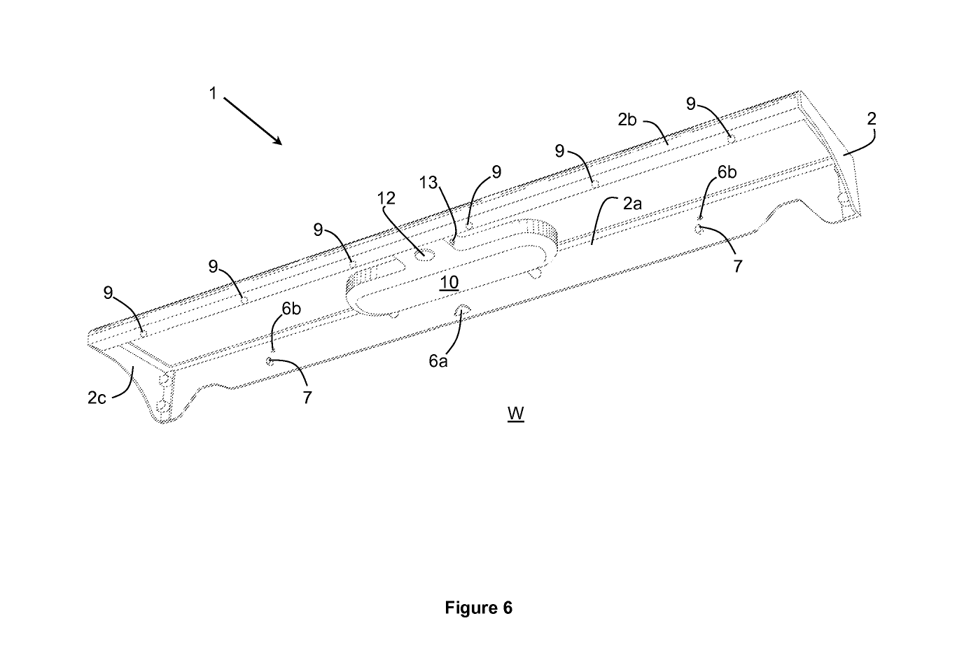

FIG. 6 illustrates a bottom perspective view of the exemplary housing 2. The proximal portion 2a of the housing 2 includes a device hanging fastener 6a that, in the illustrated embodiment, is a center hanging hole that may engage fasteners (e.g., screws, nails, etc.) attached to the wall W. The device hanging fastener 6a is the primary means for hanging the housing 2. The device hanging fastener 6a is self-leveling because it is located at the center of the proximate portion 2a of the housing 2 and the housing 2 and the poster bars 3 and 4 are weight balanced about the location of the device hanging fastener 6a. Therefore the device hanging fastener 6a represents an easy and convenient way to hang the housing 2.

The proximal portion 2a of the housing 2 may also include device hanging fasteners 6b such as, for example, holes or brackets that may be attached to the housing 2. The device hanging fasteners 6b may be secondary means for hanging the housing 2 to the wall W and may be used instead of or in addition to the device hanging fastener 6a.

The proximal portion 2a of the housing 2 is proximate the wall W when the poster display device 1 is mounted to the wall W by using the device hanging fasteners 6a-b. In the illustrated embodiment, the device 1 includes one device hanging fastener 6a and two device hanging fasteners 6b that correspond to holes that may engage fasteners (e.g., screws, nails, etc.) attached to the wall W. In other embodiments, the device 1 may include more or fewer than the illustrated number of device hanging fasteners 6a-b or the device 1 may include device hanging fasteners different from the shown holes (e.g., wires, brackets, hooks, Velcro®, adhesives, etc.)

The housing 2 also includes light sources 9 mounted along the length of the distal portion 2b of the housing 2. The light sources 9 may be light emitting diodes (LED), incandescent light bulbs, white light sources, colored light sources, ultraviolet light sources, etc. The housing 2 also includes a power circuit 10 attached to the housing 2 to provide power to the light sources 9. The power circuit 10 may include batteries. The power circuit 10 may also include a compartment 11 for the batteries. (See FIGS. 1, 4 and 5.) The power circuit 10 may also include an AC or DC power cord or adapter (not shown). The power circuit 10 also includes an on/off switch 12 that, when operated to the on position, activates the power circuit 10 providing power to the light sources 9.

The power circuit 10 may also include a light mode switch 13 that controls light modes of the poster display device 1. Light modes of the poster display device 1 may include on (i.e., the light sources 9 are continuously on), off (i.e., the light sources 9 are continuously off), on-timer or auto-off (i.e., the light sources 9 are on for a certain period of time and automatic turn off thereafter), etc.

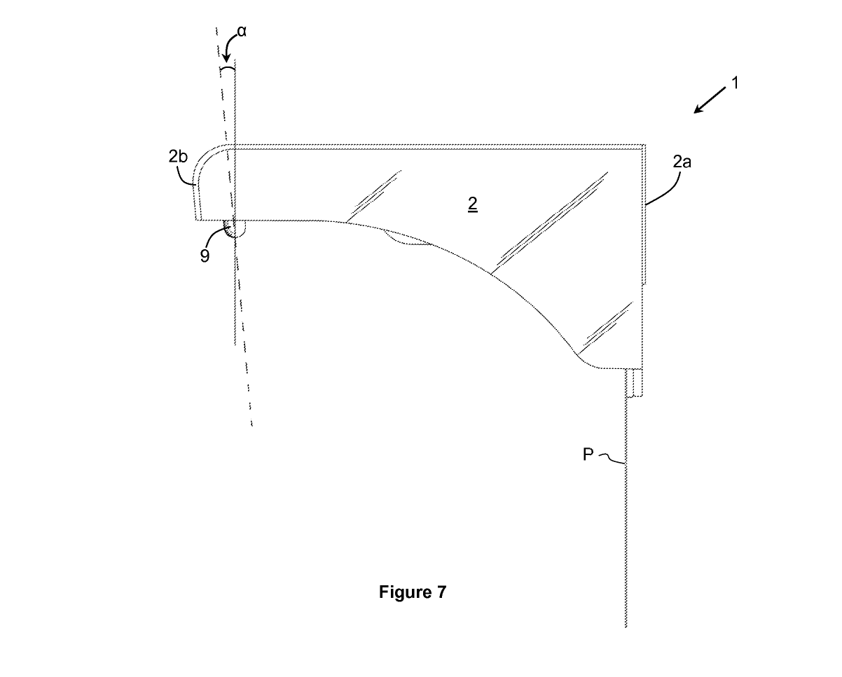

FIG. 7 illustrates a side view of the exemplary poster display device 1. Because the distal portion 2b where the light sources 9 reside is distal the proximate portion 2a from which the poster P hangs, a horizontal distance exists between the light sources 9 and the poster P. Moreover, the light sources 9 are oriented such that, when the power circuit 10 is activated and the poster P held by the top poster bar 3 is attached to the housing 2, a significant amount (e.g., a majority) of the light emitted from the light sources reaches a majority of the poster P. The optical axes of the light sources 9 are angled an angles a towards the poster P. In the illustrated embodiment, the angle α is 5 degrees. In other embodiments, the angle α is in the range of between 1 and 10 degrees, inclusive. In other embodiments, the angle α is larger than 10 degrees or smaller than 1 degree. In one embodiment, the light sources 9 may be angled at different angles; i.e., one or more of the light sources 9 may be angled at an angle different from an angle at which one or more of the other light sources 9 are angled.

This way the poster displaying device 1 holds the poster P extended upon the wall W and shines light upon the poster P. The poster P is elegantly displayed and may be properly seen even in a dark room. Moreover, installing and removing the poster P using the device 1 only requires removing the top poster bar 3 from the housing 2 (i.e., disengaging the fasteners 7 from the fasteners 8) and releasing the poster P by sliding the clips 5 along the first poster engaging portion 4a and the second poster engaging portion 4b in the opposite direction as when installing the poster P. This releases the poster P from the clips 5. The housing 2 may remain mounted to the wall W for a new poster to be displayed. This is a relatively quick and easy procedure that causes minimal to no damage to the wall W.

While example systems, methods, and so on, have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, and illustrative examples shown or described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (3D. Ed. 1995).

What is claimed is:

1. A poster display device comprising:
a housing having at least one wall mounting fastener configured to mount the poster display device to a wall;
a plurality of LED distributed along a length of the housing;
a power circuit attached to the housing and configured to provide power to the plurality of LED;
poster hanging fasteners distributed along the length of the housing;
a top poster bar configured to hold to a top edge of the poster, the top poster bar including housing engaging fasteners disposed along a length of the top poster bar to correspond to locations of the poster hanging fasteners of the housing such that the poster held by the top poster bar attaches to the housing by the poster hanging fasteners engaging the housing engaging fasteners; and
a bottom poster bar configured to hold to a bottom edge of the poster, the bottom poster bar providing weight at the bottom edge of the poster; wherein
the plurality of LED are oriented such that, when the poster held by the top poster bar is attached to the housing by the poster hanging fasteners engaging the housing engaging fasteners and the power circuit is active, the light emitted from the plurality of LED is directed at the poster.

2. The poster display device of claim 1, wherein the housing includes a proximal portion including the at least one wall mounting fastener and the poster hanging fasteners, the proximal portion proximate the wall when the poster display device is mounted to the wall.

3. The poster display device of claim 1, wherein the housing includes a distal portion to which the plurality of LED are attached, the distal portion distal the proximate portion such that when the poster held by the top poster bar is attached to the housing, a horizontal distance exists between the plurality of LED and the poster and wherein optical axes of the light sources are oriented at angles between 1 and 10 degrees relative to the poster such that light emitted from the plurality of LED reaches a majority of the poster.

4. The poster display device of claim 1, wherein the power circuit includes a light mode switch that controls light modes of the poster display device, the light modes of the poster display device including a first mode in which, when the power circuit is activated, the light sources are continuously on and a second mode in which, when the power circuit is activated, the light sources turn on for a period of time and automatically turn off thereafter.

5. The poster display device of claim 1, wherein the top poster bar includes at least one clip to hold the top edge of the poster and each clip includes a first poster engaging portion, a second poster engaging portion opposite the first poster engaging portion and a hinge portion hingedly connecting the first poster engaging portion and the second poster engaging portion, each clip further including a locking element disposed in relation to the first poster engaging portion and the second poster engaging portion such that as the locking element slides with the first poster engaging portion and the second poster engaging portion therebetween, the locking element urges the first poster engaging portion and the second poster engaging portion towards each other trapping the poster therebetween.

6. The poster display device of claim 1, wherein the top poster bar includes at least one clip to hold the top edge of the poster and each clip includes a first poster engaging portion, a second poster engaging portion opposite the first poster engaging portion and a hinge portion hingedly connecting the first poster engaging portion and the second poster engaging portion, each clip further including a u-shaped locking element sandwiching the first poster engaging portion and the second poster engaging portion between a main opening of the locking element such that as the locking element slides with the first poster engaging portion and the second poster engaging portion therebetween, the locking element urges at least one of the first poster engaging portion and the second poster engaging portion towards the other trapping the poster therebetween.

7. A poster display device comprising:
a top poster bar including clips configured to connect to a top edge of the poster and at least one housing engaging fastener disposed along a length of the top poster bar;
a bottom poster bar including clips configured to connect to a bottom edge of the poster; and
a housing including at least one device hanging fastener attached to the housing and configured to mount the device to a wall and at least one poster hanging fastener corresponding to the at least one housing engaging fastener of the top poster bar such that the poster held by the clips of the top poster bar attaches to the housing by the poster hanging fasteners of the housing engaging the housing engaging fasteners of the top poster bar, wherein
the housing includes light sources distributed along a length of the housing oriented such that light emitted from the light sources is directed at the poster when the poster held by the top poster bar is attached to the housing by the poster hanging fasteners of the housing engaging the housing engaging fasteners of the top poster bar.

8. The poster display device of claim 7, wherein the housing includes a proximal portion including the at least one device hanging fastener and the poster hanging fasteners the proximal portion proximate the wall when the poster display device is mounted to the wall.

9. The poster display device of claim 7, wherein the housing includes a proximal portion including the at least one device hanging fastener and the poster hanging fasteners, the proximal portion proximate the wall when the poster display device is mounted to the wall, and
wherein the housing includes a distal portion to which the light sources are attached, the distal portion distal the proximate portion such that, when the poster held by the clips of the top poster bar is attached to the housing, a horizontal distance exists between the light sources and the poster and optical axes of the light sources are oriented at angles between 1 and 10 degrees relative to the poster.

10. The poster display device of claim 7, wherein the poster hanging fasteners of the housing or the housing engaging fasteners of the top poster bar correspond to hooks and the other of the poster hanging fasteners of the housing or the housing engaging fasteners of the top poster bar correspond to corresponding holes such that the poster held by the clips of the top poster bar attaches to the housing by the hooks engaging the holes.

11. The poster display device of claim 7, wherein the housing includes a power circuit including a power switch electrically connected to the light sources and a light mode switch that controls light modes of the poster display device, the light modes of the poster display device including a first mode in which, when the power switch is in an on position, the light sources are continuously on and a second mode in which, when the power switch is in the on position, the light sources are on for a period of time and automatically turn off thereafter.

12. The poster display device of claim 7, wherein the light sources are selected from the group consisting of:
LED,
incandescent light bulbs,
white light sources,
colored light sources, and
ultraviolet light sources.

13. The poster display device of claim 7, wherein each of the clips includes a first poster engaging portion, a second poster engaging portion opposite the first poster engaging portion and a hinge portion hingedly connecting the first poster engaging portion and the second poster engaging portion, each of the clips further including a locking element disposed in relation to the first poster engaging portion and the second poster engaging portion such that as the locking element slides with the first poster engaging portion and the second poster engaging portion therebetween, the locking element urges the first poster engaging portion and the second poster engaging portion towards each other trapping the poster therebetween.

14. The poster display device of claim 7, wherein each of the clips includes a first poster engaging portion, a second poster engaging portion opposite the first poster engaging portion and a hinge portion hingedly connecting the first poster engaging portion and the second poster engaging portion, each of the clips further including a u-shaped locking element sandwiching the first poster engaging portion and the second poster engaging portion between a main opening of the locking element such that as the locking element slides with the first poster engaging portion and the second poster engaging portion therebetween, the locking element urges at least one of the first poster engaging portion and the second poster engaging portion towards the other trapping the poster therebetween.

15. A housing for a poster display device, the housing comprising:
light sources distributed along a length of the housing;
a power circuit attached to the housing and configured to provide power to the light sources;
at least one device hanging fastener configured to mount the poster display device to a wall; and
at least one poster hanging fasteners distributed along the length of the housing and configured to connect to corresponding housing engaging fasteners of at least one poster holding device for holding the poster; wherein
the light sources are distributed along the length of the housing oriented such that, when the poster held by the at least one poster holding device is attached to the housing by the by the poster hanging fasteners engaging the housing engaging fasteners and the power circuit is active, a majority of the light emitted from the light sources is directed at the poster.

16. The housing of claim 15, comprising:
a proximal portion including or having attached thereon the at least one poster hanging fastener, the proximal portion proximate the wall when the poster display device is mounted to the wall; and
a distal portion to which the light sources are attached, the distal portion distal the proximate portion such that when the poster held by the clips of the top poster bar is attached to the housing, a horizontal distance exists between the light sources and the poster and optical axes of the light sources are oriented at angles between 1 and 10 degrees relative to the poster.

17. The housing of claim 15, comprising:
a proximal portion including or having attached thereon the at least one poster hanging fastener, the proximal portion proximate the wall when the poster display device is mounted to the wall; and
a distal portion to which the light sources are attached, the distal portion distal the proximate portion such that when the poster held by the clips of the top poster bar is attached to the housing, a horizontal distance exists between the light sources and the poster such that light emitted from the light sources reaches a majority of the poster.

18. The housing of claim 15, wherein one of the poster hanging fasteners and the housing engaging fasteners corresponds to hooks and the other of the poster hanging fasteners and the housing engaging fasteners corresponds to corresponding holes such that the poster held by the at least one poster holding device attaches to the housing by the hooks engaging the holes.

19. The housing of claim 15, wherein the power circuit includes an on/off switch electrically connected to the light sources and a light mode switch that controls light modes, the light modes including a first mode in which, when the on/off switch is in an on position, the light sources are continuously on and a second mode in which, when the on/off switch is in the on position, the light sources are on for a period of time and automatically turn off thereafter.

20. The housing of claim 15, wherein the light sources are selected from the group consisting of:
LED,
incandescent light bulbs,
white light sources,
colored light sources, and
ultraviolet light sources.
